(19) United States
(12) Patent Application Publication
(10) Pub. No.: US 2023/0021176 A1
(43) Pub. Date: Jan. 19, 2023

(54) MOTOR

(71) Applicant: DENSO CORPORATION, Kariya-city (JP)

(72) Inventor: Ryosuke OGURI, Kariya-city (JP)

(73) Assignee: DENSO CORPORATION, Kariya-city (JP)

(21) Appl. No.: 17/952,819

(22) Filed: Sep. 26, 2022

Related U.S. Application Data
(63) Continuation of application No. PCT/JP2021/000236, filed on Jan. 6, 2021.

(30) Foreign Application Priority Data
Mar. 24, 2020 (JP) 2020-052997

(51) Int. Cl. H02K 13/10

(52) U.S. Cl. CPC H02K 13/105

(57) ABSTRACT

A motor includes a rotating shaft, an armature core, a plurality of coils, a commutator and a pair of brushes. The plurality of coils include three or more coil pairs each of which consists of a pair of coils configured to be point-symmetrical with respect to a rotation center axis. One of the three or more coil pairs constitutes a pair of number-of-turns adjustment coils which would have a lowest inductance in the plurality of coils if all the plurality of coils had the same number of turns. The number of turns of the pair of number-of-turns adjustment coils is set to be larger than the number of turns of any of the remainder of the three or more coil pairs. The inductance of the pair of number-of-turns adjustment coils is set to be higher than the inductance of any of the remainder of the three or more coil pairs.

### CROSS-REFERENCE TO RELATED APPLICATIONS

The present application is a continuation application of International Application No. PCT/JP2021/000236 filed on Jan. 6, 2021, which is based on and claims priority from Japanese Patent Application No. 2020-052997 filed on Mar. 24, 2020. The entire contents of these applications are incorporated by reference into the present application.

### BACKGROUND

### 1 Technical Field

The present disclosure relates to motors.

### 2 Description of Related Art

Japanese Patent No. JP 5306346 B2 discloses a DC motor that is used as an actuator in a motor vehicle. In the motor disclosed in the patent document, energization of motor windings (or a plurality of coils) constituting part of an armature is switched by brushes and a commutator. In addition, in the motor disclosed in the patent document, a desired frequency signal can be generated by changing the number of conductors (or the number of coil turns) for each of the motor windings.

### SUMMARY

However, with the configuration of the motor disclosed in the aforementioned patent document, sparks may be generated between the brushes and the commutator depending on the setting of the numbers of conductors (or the numbers of coil turns) of the motor windings. The generation of sparks between the brushes and the commutator would cause an increase in the amount of wear of the brushes and generation of abnormal noise.

The present disclosure has been accomplished in view of the above problem.

According to the present disclosure, there is provided a motor which includes a rotating shaft, an armature core, a plurality of coils, a commutator and a pair of brushes. The rotating shaft is rotatably supported. The armature core is provided to be rotatable together with the rotating shaft. The plurality of coils are formed of electrically conductive windings each of which is wound in an annular shape around the armature core. The plurality of coils are arranged in a rotation circumferential direction. The commutator is provided to be rotatable together with the rotating shaft. The commutator is connected with the windings forming the plurality of coils. The pair of brushes are provided in contact with the commutator so as to slide on the commutator rotating together with the rotating shaft and thereby switch energization of each of the plurality of coils. Moreover, the plurality of coils include three or more coil pairs each of which consists of a pair of coils configured to be point-symmetrical with each other with respect to a rotation center axis. Any of the three or more coil pairs would have a different inductance from the remainder of the three or more coil pairs if all the plurality of coils had the same number of turns. One of the three or more coil pairs constitutes a pair of number-of-turns adjustment coils which would have a lowest inductance in the plurality of coils if all the plurality of coils had the same number of turns. The number of turns of the pair of number-of-turns adjustment coils is set to be larger than the number of turns of any of the remainder of the three or more coil pairs. The inductance of the pair of number-of-turns adjustment coils is set to be higher than the inductance of any of the remainder of the three or more coil pairs.

With the above configuration of the motor according to the present disclosure, it becomes possible to suppress generation of sparks between the pair of brushes and the commutator.

### BRIEF DESCRIPTION OF THE DRAWINGS

FIG. 1 is a plan view of part of a motor according to an embodiment.

FIG. 2 is a schematic diagram illustrating wiring of an armature of the motor shown in FIG. 1.

FIG. 3 is a graph illustrating the energy of sparks generated between brushes and a commutator in the motor.

FIG. 4 is a graph illustrating the relationship between the coil numbers and the inductances of the coils in the motor.

FIG. 5 is a graph illustrating the relationship between the coil numbers and the electrical resistances of the coils in the motor.

FIG. 6 is a graph illustrating the relationship between the coil numbers and the numbers of turns of the coils in the motor.

FIG. 7A is a schematic diagram illustrating the directions and amplitudes of commutated electric currents during rotation of a rotor of the motor.

FIG. 7B is a schematic diagram illustrating the directions and amplitudes of the commutated electric currents at a more advanced stage of the rotation of the rotor than FIG. 7A.

FIG. 7C is a schematic diagram illustrating the directions and amplitudes of the commutated electric currents at a more advanced stage of the rotation of the rotor than FIG. 7B.

FIG. 7D is a schematic diagram illustrating the directions and amplitudes of the commutated electric currents at a more advanced stage of the rotation of the rotor than FIG. 7C.

FIG. 7E is a schematic diagram illustrating the directions and amplitudes of the commutated electric currents at a more advanced stage of the rotation of the rotor than FIG. 7D.

FIG. 8 is a graph comparatively showing the spark energy in the motor according to the embodiment and the spark energy in a motor according to a comparative example.

FIG. 9 is a graph illustrating the relationship between the coil numbers and the numbers of turns of the coils in a motor according to a modification.

FIG. 10 is a schematic diagram corresponding to FIG. 2 and illustrating wiring of an armature of a motor according to another modification.

### DESCRIPTION OF EMBODIMENTS

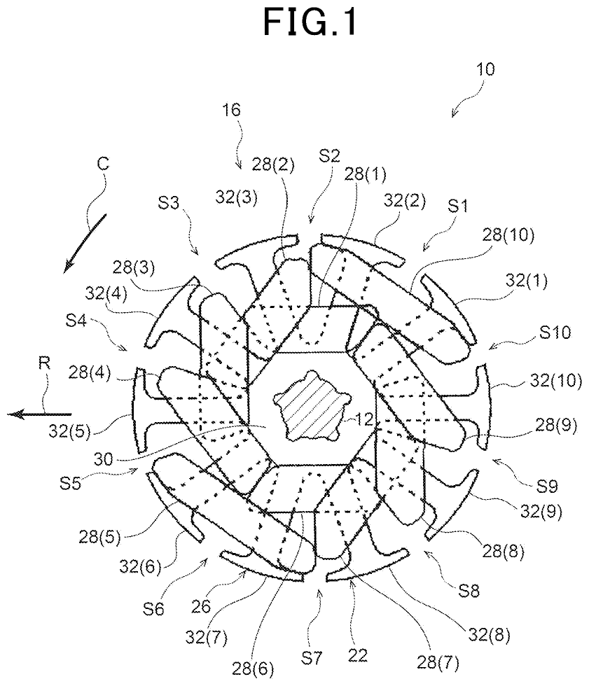

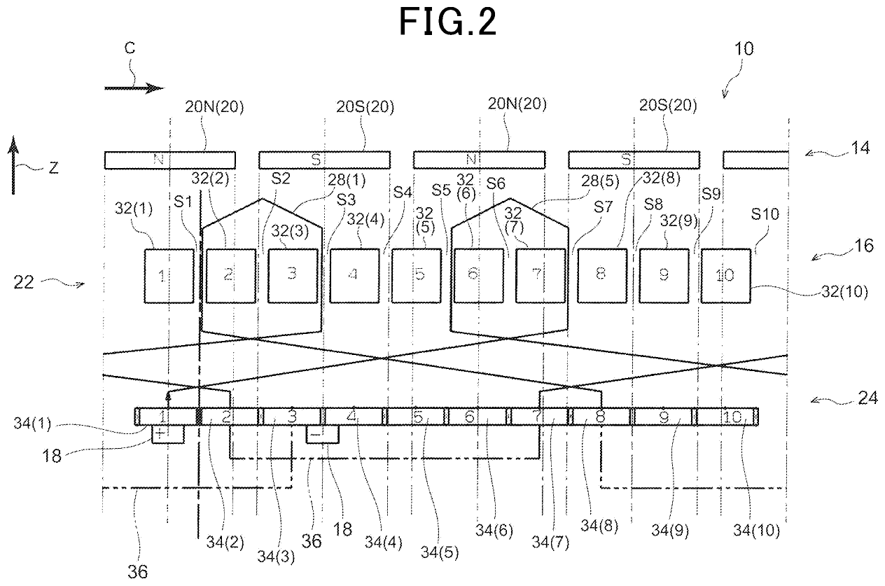

A motor 10 according to an embodiment of the present disclosure will be described with reference to FIGS. 1 and 2. It should be noted that the directions suitably indicated by arrows Z, R and C in the drawings respectively represent one side in a rotation axial direction of a rotating shaft 12 of the motor 10, an outer side in a rotation radial direction of the rotating shaft 12 and one side in a rotation circumferential direction of the rotating shaft 12. Moreover, it also should be noted that unless otherwise specified, the rotation axial direction, rotation radial direction and rotation circumferential direction of the rotating shaft 12 will be simply referred to as the axial direction, the radial direction and the circumferential direction hereinafter.

As shown in FIGS. 1 and 2, the motor 10 according to the present embodiment is a 4-pole 10-slot DC motor which includes a stator 14, a rotor 16 and a pair of brushes 18.

As shown in FIG. 2, the stator 14 is formed by, for example, fixing a plurality of magnets 20 to a radially inner surface of a cylindrical housing. More particularly, in the present embodiment, the stator 14 includes four magnets 20. Specifically, two magnets 20N each having an N pole on the radially inner side and two magnets 20S each having an S pole on the radially inner side are arranged alternately and at equal intervals along the circumferential direction.

As shown in FIGS. 1 and 2, the rotor 16 is arranged radially inside the stator 14. The rotor 16 includes the aforementioned rotating shaft 12 that is rotatably supported by bearings (not shown), and an armature 22 and a commutator 24 (see FIG. 2) both of which are fixed to the rotating shaft 12.

As shown in FIG. 1, the armature 22 includes an armature core 26 formed of a magnetic material, and a plurality of coils 28 formed around the armature core 26.

The armature core 26 has an axial center portion 30 constituting a radially inner portion of the armature core 26. The rotating shaft 12 is fixed in a center hole of the axial center portion 30 by press fitting or the like. Moreover, the armature core 26 also has a plurality (e.g., ten in the present embodiment) of tooth portions 32 each protruding radially outward from the axial center portion 30 and having a substantially T-shape in an axial view. In addition, the tooth portions 32 are arranged at equal intervals in the circumferential direction.

Here, numbers are sequentially assigned to the tooth portions 32 along the circumferential direction. Moreover, these numbers are shown in parentheses at the end of the reference numeral 32 designating each of the tooth portions 32. In addition, these numbers will be referred to as the “tooth portion numbers” hereinafter.

Furthermore, those spaces each of which is formed between a circumferentially-adjacent pair of the tooth portions 32 will be referred to as the “slots” hereinafter. More particularly, in the present embodiment, there are formed ten slots in the armature core 26. In addition, reference signs Si to S10 are sequentially assigned to the ten slots along the circumferential direction. Specifically, the slot formed between the first tooth portion 32(1) and the second tooth portion 32(2) is designated by the reference sign S1. Further, the slot formed between the second tooth portion 32(2) and the third tooth portion 32(3) is designated by the reference sign S2. In the same manner as above, all the remaining slots are designated respectively by the reference signs S3 to S10. Each of the coils 28 is formed by winding an electrically conductive wire in an annular shape around the armature core 26.

Specifically, the first coil 28(1) is formed by winding a wire between the slot Si and the slot S3 and around the second tooth portion 32(2) and the third tooth portion 32(3). Moreover, the first coil 28(1) has a first circumferential side portion located at a position corresponding to a radially inner end portion of the third tooth portion 32(3) and a second circumferential side portion located at a position corresponding to a radially inner end portion of the second tooth portion 32(2). In addition, those numbers which are suffixed in parentheses to the reference numeral 28 designating each of the coils 28 will be referred to as the “coil numbers” hereinafter.

The second coil 28(2) is formed by winding a wire between the slot S2 and the slot S4 and around the third tooth portion 32(3) and the fourth tooth portion 32(4). Moreover, the second coil 28(2) has a first circumferential side portion located at a position corresponding to a radially inner end portion of the fourth tooth portion 32(4) and a second circumferential side portion located radially outside the first circumferential side portion of the first coil 28(1).

The third coil 28(3) is formed by winding a wire between the slot S3 and the slot S5 and around the fourth tooth portion 32(4) and the fifth tooth portion 32(5). Moreover, the third coil 28(3) has a first circumferential side portion located at a position corresponding to a radially inner end portion of the fifth tooth portion 32(5) and a second circumferential side portion located radially outside the first circumferential side portion of the second coil 28(2).

The fourth coil 28(4) is formed by winding a wire between the slot S4 and the slot S6 and around the fifth tooth portion 32(5) and the sixth tooth portion 32(6). Moreover, the fourth coil 28(4) has a first circumferential side portion located at a position corresponding to a radially inner end portion of the sixth tooth portion 32(6) and a second circumferential side portion located radially outside the first circumferential side portion of the third coil 28(3).

The fifth coil 28(5) is formed by winding a wire between the slot S5 and the slot S7 and around the sixth tooth portion 32(6) and the seventh tooth portion 32(7). Moreover, the fifth coil 28(5) has a first circumferential side portion located at a position corresponding to a radially outer end portion of the seventh tooth portion 32(7) and a second circumferential side portion located at a position corresponding to a radially outer end portion of the sixth tooth portion 32(6) and radially outside the first circumferential side portion of the fourth coil 28(4).

The sixth coil 28(6) is formed by winding a wire between the slot S6 and the slot S8 and around the seventh tooth portion 32(7) and the eighth tooth portion 32(8). Moreover, the sixth coil 28(6) has a first circumferential side portion located at a position corresponding to a radially inner end portion of the eighth tooth portion 32(8) and a second circumferential side portion located at a position corresponding to a radially inner end portion of the seventh tooth portion 32(7) and radially inside the first circumferential side portion of the fifth coil 28(5).

The seventh coil 28(7) is formed by winding a wire between the slot S7 and the slot S9 and around the eighth tooth portion 32(8) and the ninth tooth portion 32(9). Moreover, the seventh coil 28(7) has a first circumferential side portion located at a position corresponding to a radially inner end portion of the ninth tooth portion 32(9) and a second circumferential side portion located radially outside the first circumferential side portion of the sixth coil 28(6).

The eighth coil 28(8) is formed by winding a wire between the slot S8 and the slot S10 and around the ninth tooth portion 32(9) and the tenth tooth portion 32(10). Moreover, the eighth coil 28(8) has a first circumferential side portion located at a position corresponding to a radially inner end portion of the tenth tooth portion 32(10) and a second circumferential side portion located radially outside the first circumferential side portion of the seventh coil 28(7).

The ninth coil 28(9) is formed by winding a wire between the slot S9 and the slot Si and around the tenth tooth portion 32(10) and the first tooth portion 32(1). Moreover, the ninth coil 28(9) has a first circumferential side portion located at a position corresponding to a radially inner end portion of the first tooth portion 32(1) and a second circumferential side portion located radially outside the first circumferential side portion of the eighth coil 28(8).

The tenth coil 28(10) is formed by winding a wire between the slot S10 and the slot S2 and around the first tooth portion 32(1) and the second tooth portion 32(2). Moreover, the tenth coil 28(10) has a first circumferential side portion located at a position corresponding to a radially outer end portion of the second tooth portion 32(2) and radially outside the second circumferential side portion of the first coil 28(1) and a second circumferential side portion located at a position corresponding to a radially outer end portion of the first tooth portion 32(1) and radially outside the first circumferential side portion of the ninth coil 28(9).

The first coil 28(1) and the sixth coil 28(6) are configured to be point-symmetrical with each other with respect to the rotation center axis. The second coil 28(2) and the seventh coil 28(7) are configured to be point-symmetrical with each other with respect to the rotation center axis. The third coil 28(3) and the eighth coil 28(8) are configured to be point-symmetrical with each other with respect to the rotation center axis. The fourth coil 28(4) and the ninth coil 28(9) are configured to be point-symmetrical with each other with respect to the rotation center axis. The fifth coil 28(5) and the tenth coil 28(10) are configured to be point-symmetrical with each other with respect to the rotation center axis. Therefore, in the following explanation, the sixth coil 28(6), the seventh coil 28(7), the eighth coil 28(8), the ninth coil 28(9) and the tenth coil 28(10) will be described, depending on the situation, as being respectively identical or corresponding to the first coil 28(1), the second coil 28(2), the third coil 28(3), the fourth coil 28(4) and the fifth coil 28(5).

As shown in FIG. 2, the commutator 24 includes a fixed portion (not shown) that is fixed to the rotating shaft 12 (see FIG. 1), and a plurality (e.g., ten in the present embodiment) of commutator segments 34 that are formed of a copper plate or the like and fixed to a radially outer surface of the fixed portion. The commutator segments 34 are arranged at equal intervals along the circumferential direction. Here, numbers are sequentially assigned to the commutator segments 34 along the circumferential direction. Moreover, these numbers are shown in parentheses at the end of the reference numeral 34 designating each of the commutator segments 34. In addition, these numbers will be referred to as the “commutator segment numbers” hereinafter.

Two end portions of the winding constituting the first coil 28(1) are connected respectively to the seventh commutator segment 34(7) and the eighth commutator segment 34(8). Two end portions of the winding constituting the fifth coil 28(5) are connected respectively to the first commutator segment 34(1) and the second commutator segment 34(2). Moreover, although not shown in the drawings, two end portions of the winding constituting the second coil 28(2) are connected respectively to the eighth commutator segment 34(8) and the ninth commutator segment 34(9). Two end portions of the winding constituting the third coil 28(3) are connected respectively to the ninth commutator segment 34(9) and the tenth commutator segment 34(10). Two end portions of the winding constituting the fourth coil 28(4) are connected respectively to the tenth commutator segment 34(10) and the first commutator segment 34(1). Two end portions of the winding constituting the sixth coil 28(6) are connected respectively to the second commutator segment 34(2) and the third commutator segment 34(3). Two end portions of the winding constituting the seventh coil 28(7) are connected respectively to the third commutator segment 34(3) and the fourth commutator segment 34(4). Two end portions of the winding constituting the eighth coil 28(8) are connected respectively to the fourth commutator segment 34(4) and the fifth commutator segment 34(5). Two end portions of the winding constituting the ninth coil 28(9) are connected respectively to the fifth commutator segment 34(5) and the sixth commutator segment 34(6). Two end portions of the winding constituting the tenth coil 28(10) are connected respectively to the sixth commutator segment 34(6) and the seventh commutator segment 34(7).

The second commutator segment 34(2) and the seventh commutator segment 34(7) are electrically connected with each other via a connecting wire 36. The third commutator segment 34(3) and the eighth commutator segment 34(8) are electrically connected with each other via a connecting wire 36. Moreover, although not shown in the drawings, the fourth commutator segment 34(4) and the ninth commutator segment 34(9) are electrically connected with each other via a connecting wire 36. The fifth commutator segment 34(5) and the tenth commutator segment 34(10) are electrically connected with each other connected via a connecting wire 36. The first commutator segment 34(1) and the fifth commutator segment 34(5) are electrically connected with each other via a connecting wire 36.

The pair of brushes 18 are provided, on the radially outer side of the commutator 24, at positions where they can make contact with each of the commutator segments 34 of the commutator 24 during rotation of the rotor 16. The pair of brushes 18 are supported by a brush holder (not shown) in such a manner that they can move radially, but their circumferential and axial movements are restricted.

Moreover, the pair of brushes 18 are urged to the commutator 24 side (i.e., radially inward) by springs (not shown) provided in the brush holder. Furthermore, in the present embodiment, the circumferential positions of the pair of brushes 18 are set so that when one of the pair of brushes 18 (e.g., the positive-side brush 18) is located at a position corresponding to a circumferential central portion of one of the commutator segments 34, the other of the pair of brushes 18 (e.g., the negative-side brush 18) is located between one circumferentially-adjacent pair of the commutator segments 34. Specifically, the circumferential positions of the pair of brushes 18 are set so that when one of the pair of brushes 18 (e.g., the positive-side brush 18) is located at a position corresponding to a circumferential central portion of the first commutator segment 34(1), the other of the pair of brushes 18 (e.g., the negative-side brush 18) is located between the third commutator segment 34(3) and the fourth commutator segment 34(4).

In the above-described motor 10 according to the present embodiment, energization of each of the coils 28 is switched by sliding movement of the pair of brushes 18 on the commutator segments 34 of the commutator 24. Consequently, the rotor 16 can rotate continuously.

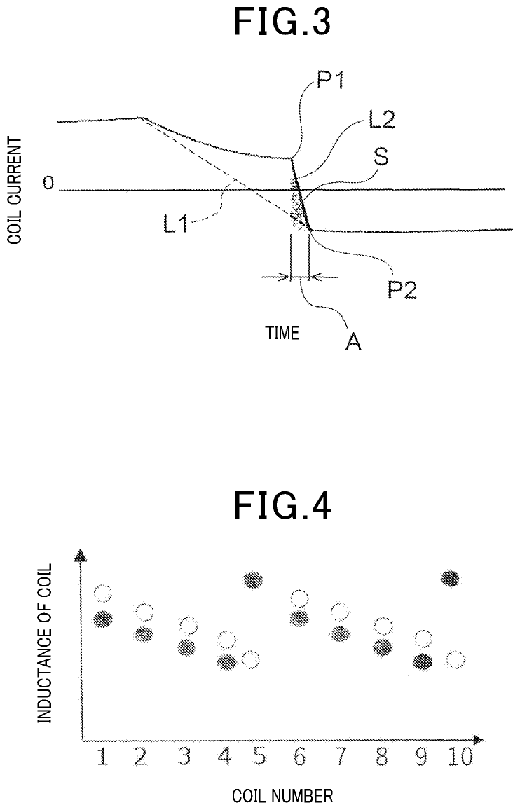

In FIG. 3, there is shown a graph where the vertical axis represents the amplitude and direction of electric current flowing through the coils 28 and the horizontal axis represents time. In addition, one side and the other side of the direction of the electric current flowing through the coils 28 respectively correspond to the positive and negative sides on the vertical axis of the graph. As shown in the graph, it is ideal that the direction of the electric current flowing through the coils 28 be switched gently as indicated by the dashed line L1. However, depending on the setting of the coils 28 constituting the armature 22, the direction of the electric current flowing through the coils 28 may be switched abruptly as indicated by the solid line L2. The amount of change in the electric current per unit time depends on the magnitude of the energy that generates sparks between the brushes 18 and the commutator segments 34 of the commutator 24 (hereinafter, to be referred to as the “spark energy”). In terms of increase in the amount of wear of the brushes 18 and generation of abnormal noise, it is not preferable for the spark energy to be high. In particular, in the region A indicated by the solid line L2, where the amount of change in the electric current per unit time is large, the spark energy becomes high (i.e., the area S of the portion represented by the product of the amount of change in the electric current and time in the region A becomes large), causing an increase in the amount of wear of the brushes 18 and generation of abnormal noise. Moreover, it has been known from an analysis that: the peak value P1 of the electric current to one side in the region A increases with increase in the inductances of the coils 28; and the peak value P2 of the electric current to the other side in the region A increases with decrease in the electrical resistances of the coils 28. In consideration of the above, in the motor 10 according to the present embodiment, the coils 28 are set as follows.

In FIG. 4, there is shown a graph where the vertical axis represents the inductances of the coils 28 and the horizontal axis represents the coil numbers. In addition, in FIG. 4, the two-dot chain lines indicate the inductances of the coils 28 in the case of setting all the coils 28 to have the same number of turns (e.g., 34 turns) whereas the solid lines indicate the inductances of the coils 28 in the case of applying a setting of the coils 28 for suppressing the above-described sparks.

It can be seen from FIG. 4 that in the case of setting all the coils 28 to have the same number of turns, the inductances of the coils 28 decrease with increase in the coil numbers from the first to the fifth (also from the sixth to the tenth). The differences between the inductances of the coils 28 are mainly due to the differences in magnetic permeability between those portions (i.e., the tooth portions 32) which function as cores of the coils 28.

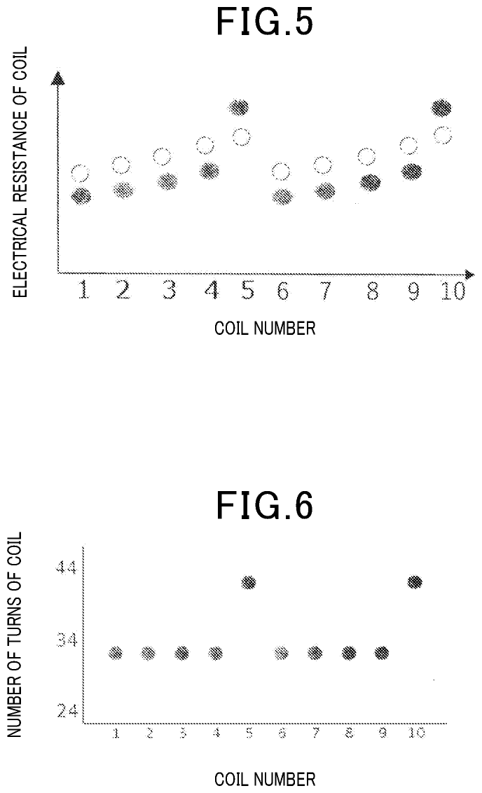

In FIG. 5, there is shown a graph where the vertical axis represents the electrical resistances of the coils 28 and the horizontal axis represents the coil numbers. In addition, in FIG. 5, the two-dot chain lines indicate the electrical resistances of the coils 28 in the case of setting all the coils 28 to have the same number of turns (e.g., 34 turns) whereas the solid lines indicate the electrical resistances of the coils 28 in the case of applying the setting of the coils 28 for suppressing the above-described sparks.

It can be seen from FIG. 5 that in the case of setting all the coils 28 to have the same number of turns, the electrical resistances of the coils 28 increase with increase in the coil numbers from the first to the fifth (also from the sixth to the tenth). The differences between the electrical resistances of the coils 28 are mainly due to the differences between the lengths of the windings respectively constituting the coils 28.

As shown in FIG. 3, in terms of reducing the peak value P1 of the electric current to one side in the region A where the amount of change in the electric current per unit time is large, it is effective to reduce the inductances of the coils 28. On the other hand, in terms of reducing the peak value P2 of the electric current to the other side in the region A, it is effective to increase the electrical resistances of the coils 28. In view of the above, in the present embodiment, as shown in FIGS. 4 and 5, the fifth coil 28 (also the tenth coil 28), which has the lowest inductance in the case of setting all the coils 28 to have the same number of turns, is used as a number-of-turns adjustment coil. Specifically, as shown in FIG. 6, the number of turns of the fifth coil 28 (also the number of turns of the tenth coil 28) is increased from 34 turns to 42 turns, thereby increasing the electrical resistance of the fifth coil 28 (also the electrical resistance of the tenth coil 28). Meanwhile, the numbers of turns of the first to the fourth coils 28 (also the numbers of turns of the sixth to the ninth coils 28) are reduced from 34 turns to 32 turns, thereby reducing the inductances of the first to the fourth coils 28 (also the inductances of the sixth to the ninth coils 28). In addition, by increasing the number of turns of the fifth coil 28 (also the number of turns of the tenth coil 28) from 34 turns to 42 turns and reducing the numbers of turns of the first to the fourth coils 28 (also the numbers of turns of the sixth to the ninth coils 28) from 34 turns to 32 turns, it becomes possible to generate a low-frequency signal. Consequently, it becomes possible to satisfy the demand for making the motor 10 sensorless.

Next, operation and effects of the present embodiment will be described.

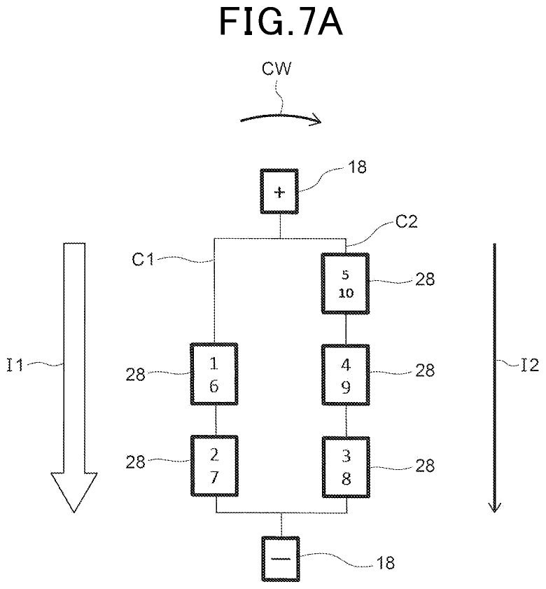

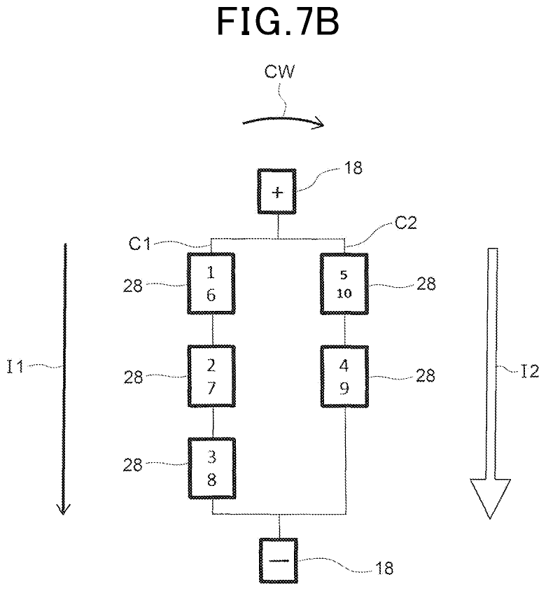

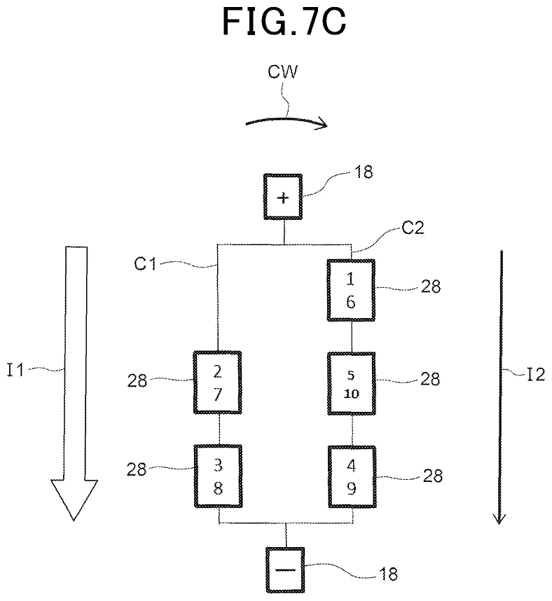

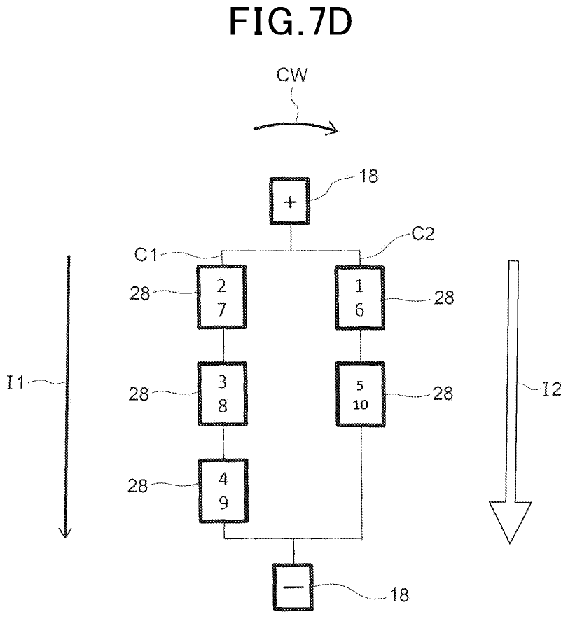

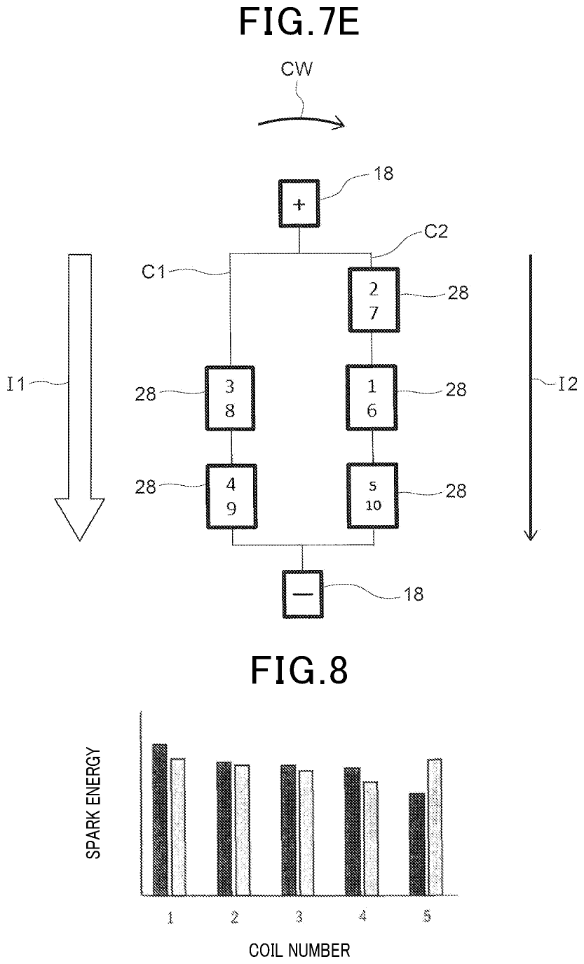

FIGS. 7A to 7E are schematic diagrams (i.e., schematic diagrams of circuits) illustrating the process of switching (or commutating) energization of each of the coils 28 via the pair of brushes 18 and the commutator 24 (see FIG. 2). In FIGS. 7A to 7E, those numbers which are shown in the rectangular frames representing the coils 28 are the coil numbers. Moreover, the direction of the electric current flowing through the circuit C1 on the left side of the pair of brushes 18 in the figures is indicated by the arrow I1; and the magnitude of the electric current flowing through the left circuit C1 is indicated by the thickness of the arrow I1. On the other hand, the direction of the electric current flowing through the circuit C2 on the right side of the pair of brushes 18 in the figures is indicated by the arrow I2; and the magnitude of the electric current flowing through the right circuit C2 is indicated by the thickness of the arrow I2. It should be noted that the higher the magnitudes of the commutated electric currents flowing through the circuits C1 and C2, the larger the thicknesses of the arrows I1 and I2 which indicate the magnitudes. In addition, the direction of rotation of the coils 28 is indicated by the arrow CW. As shown in FIG. 7A, at a stage where the fifth coil 28 (or the tenth coil 28), whose electrical resistance is increased by adjusting the number of turns thereof as described above, constitutes part of the right circuit C2, the commutated electric current 12 flowing through the right circuit C2 can be reduced as compared with the case of not adjusting the number of turns. Here, the right circuit C2 is a post-commutation circuit. As a result, at the stage where the fifth coil 28 (or the tenth coil 28) constitutes part of the right circuit C2, it is possible to suppress increase in the spark energy between the brushes 18 and the commutator segments 34 of the commutator 24.

As shown in FIG. 7B, at a more advanced stage of the rotation of the coils 28 than FIG. 7A, the fifth coil 28 (or the tenth coil 28), whose electrical resistance is increased by adjusting the number of turns thereof as described above, still does not constitute part of the left circuit Cl that is also a post-commutation circuit. At this stage, the coils 28 other than the fifth coil 28 (also other than the tenth coil 28) have the inductances thereof reduced by adjusting the numbers of turns thereof as described above. Consequently, although the commutated electric current I1 (corresponding to the aforementioned current peak value P2 (see FIG. 3)) flowing through the left circuit C1 is increased as compared with the case of not adjusting the numbers of turns, the aforementioned current peak value P1 (see FIG. 3) is reduced due to the reduction in the inductances of the coils 28 other than the fifth coil 28 (also other than the tenth coil 28). As a result, at the stage where the fifth coil 28 (or the tenth coil 28) still does not constitute part of the left circuit C1, it is also possible to suppress increase in the spark energy between the brushes 18 and the commutator segments 34 of the commutator 24.

As shown in FIG. 7C, at a more advanced stage of the rotation of the coils 28 than FIG. 7B, the fifth coil 28 (or the tenth coil 28), whose electrical resistance is increased by adjusting the number of turns thereof as described above, still constitutes part of the right circuit C2. At this stage, the commutated electric current 12 flowing through the right circuit C2 can be reduced as compared with the case of not adjusting the number of turns. As a result, at the stage where the fifth coil 28 (or the tenth coil 28) constitutes part of the right circuit C2, it is possible to suppress increase in the spark energy between the brushes 18 and the commutator segments 34 of the commutator 24. Similarly, at a stage where the fifth coil 28 (or the tenth coil 28) constitutes part of the left circuit C1, it is also possible to suppress increase in the spark energy between the brushes 18 and the commutator segments 34 of the commutator 24.

As shown in FIG. 7D, at a more advanced stage of the rotation of the coils 28 than FIG. 7C, the fifth coil 28 (or the tenth coil 28), whose electrical resistance is increased by adjusting the number of turns thereof as described above, still does not constitute part of the left circuit C1. At this stage, the coils 28 other than the fifth coil 28 (also other than the tenth coil 28) have the inductances thereof reduced by adjusting the numbers of turns thereof as described above. Consequently, although the commutated electric current I1 (corresponding to the aforementioned current peak value P2 (see FIG. 3)) flowing through the left circuit C1 is increased as compared with the case of not adjusting the numbers of turns, the aforementioned current peak value P1 (see FIG. 3) is reduced due to the reduction in the inductances of the coils 28 other than the fifth coil 28 (also other than the tenth coil 28). As a result, at the stage where the fifth coil 28 (or the tenth coil 28) still does not constitute part of the left circuit C1, it is also possible to suppress increase in the spark energy between the brushes 18 and the commutator segments 34 of the commutator 24.

As shown in FIG. 7E, at a more advanced stage of the rotation of the coils 28 than FIG. 7D, the fifth coil 28 (or the tenth coil 28), whose electrical resistance is increased by adjusting the number of turns thereof as described above, still constitutes part of the right circuit C2. At this stage, the commutated electric current 12 flowing through the right circuit C2 can be reduced as compared with the case of not adjusting the number of turns. As a result, at the stage where the fifth coil 28 (or the tenth coil 28) constitutes part of the right circuit C2, it is possible to suppress increase in the spark energy between the brushes 18 and the commutator segments 34 of the commutator 24.

Similarly, at a more advanced stage of the rotation of the coils 28 than FIG. 7E, it is also possible to suppress increase in the spark energy between the brushes 18 and the commutator segments 34 of the commutator 24. In addition, in the case of the coils 28 rotating in a direction opposite to the direction indicated by the arrow CW in the figures, it is also possible to suppress increase in the spark energy between the brushes 18 and the commutator segments 34 of the commutator 24.

In FIG. 8, there is shown a graph comparing the spark energies stored in the coils 28 in the configuration S1 where the numbers of turns of the coils 28 are not adjusted and the spark energies stored in the coils 28 in the configuration S2 where the numbers of turns of the coils 28 are adjusted as described above. As shown in FIG. 8, in the configuration S2 where the numbers of turns of the coils 28 are adjusted as described above, the spark energies stored in the first to the fourth coils 28 are reduced as compared with the configuration S1 where the numbers of turns of the coils 28 are not adjusted. Meanwhile, in the configuration S2 where the numbers of turns of the coils 28 are adjusted as described above, the spark energy stored in the fifth coil 28 is increased as compared with the configuration S1 where the numbers of turns of the coils 28 are not adjusted. However, the spark energy stored in the fifth coil 28 in the configuration S2 is lower than the peak value of the spark energies stored in the coils 28 (i.e., the spark energy stored in the first coil 28) in the configuration S1.

As described, according to the present embodiment, it becomes possible to suppress generation of sparks between the brushes 18 and the commutator segments 34 of the commutator 24 by adjusting the numbers of turns of the coils 28.

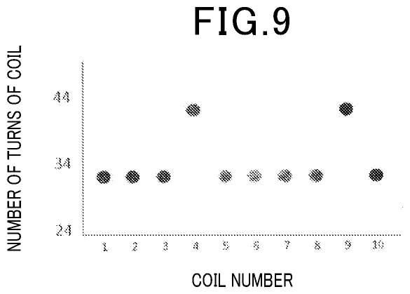

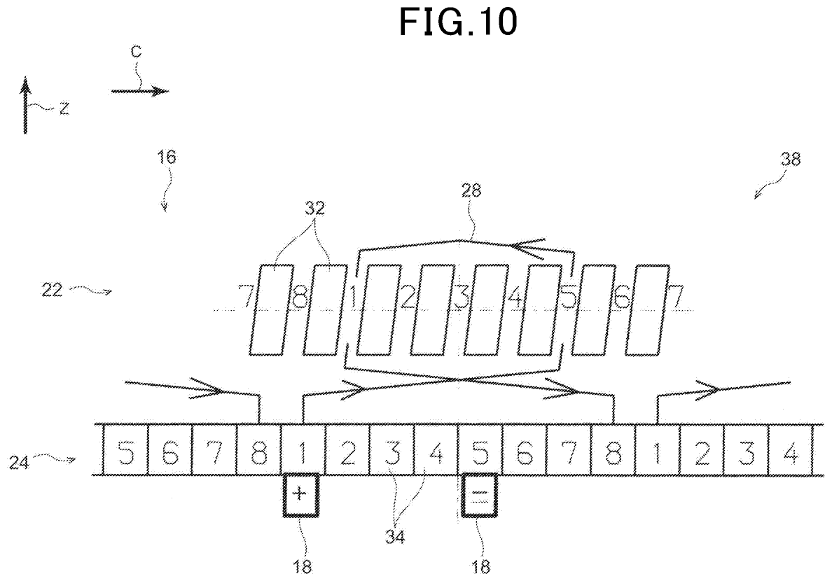

In the present embodiment, explanation is given of an example where generation of sparks between the brushes 18 and the commutator segments 34 of the commutator 24 is suppressed by increasing the number of turns of the fifth coil 28 (also the number of turns of the tenth coil 28) and reducing the numbers of turns of the first to the fourth coils 28 (also the numbers of turns of the sixth to the ninth coils 28). However, the present disclosure is not limited to this example. For instance, as shown in FIG. 9, generation of sparks between the brushes 18 and the commutator segments 34 of the commutator 24 may be suppressed alternatively by increasing the number of turns of the fourth coil 28 (also the number of turns of the ninth coil 28) and reducing the numbers of turns of the first, second, third and fifth coils 28 (also the numbers of turns of the sixth, seventh, eighth and tenth coils 28).

In the present embodiment, explanation is given of an example where the configuration for suppressing generation of sparks between the brushes 18 and the commutator segments 34 of the commutator 24 is applied to the 4-pole 10-slot motor 10. However, the present disclosure is not limited to this example. For instance, the configuration for suppressing generation of sparks between the brushes 18 and the commutator segments 34 of the commutator 24 may also be applied to a 2-pole 8-slot motor 38, part of which is schematically shown in FIG. 10.

As above, one embodiment of the present disclosure has been described. However, it goes without saying that the present disclosure is not limited to the above-described embodiment and may be implemented through various modifications to the above-described embodiment without departing from the spirit of the present disclosure.

Moreover, while the present disclosure has been described pursuant to the embodiment, it should be appreciated that the present disclosure is not limited to the embodiment and the structure. Instead, the present disclosure encompasses various modifications and changes within equivalent ranges. In addition, various combinations and modes are also included in the category and the scope of technical idea of the present disclosure.

What is claimed is:

1. A motor comprising:
a rotating shaft that is rotatably supported;
an armature core provided to be rotatable together with the rotating shaft;
a plurality of coils formed of electrically conductive windings each of which is wound in an annular shape around the armature core, the plurality of coils being arranged in a rotation circumferential direction;
a commutator provided to be rotatable together with the rotating shaft, the commutator being connected with the windings forming the plurality of coils; and
a pair of brushes provided in contact with the commutator so as to slide on the commutator rotating together with the rotating shaft and thereby switch energization of each of the plurality of coils,
wherein
the plurality of coils include three or more coil pairs, each of the three or more coil pairs consisting of a pair of coils configured to be point-symmetrical with each other with respect to a rotation center axis,
any of the three or more coil pairs would have a different inductance from the remainder of the three or more coil pairs if all the plurality of coils had the same number of turns,
one of the three or more coil pairs constitutes a pair of number-of-turns adjustment coils which would have a lowest inductance in the plurality of coils if all the plurality of coils had the same number of turns,
the number of turns of the pair of number-of-turns adjustment coils is set to be larger than the number of turns of any of the remainder of the three or more coil pairs, and
the inductance of the pair of number-of-turns adjustment coils is set to be higher than the inductance of any of the remainder of the three or more coil pairs.

2. The motor as set forth in claim 1, wherein
the pair of number-of-turns adjustment coils are located radially outermost in the plurality of coils.
